(19) United States
(12) Patent Application Publication
(10) Pub. No.: US 2017/0293964 A1
(43) Pub. Date: Oct. 12, 2017

(54) Consumable Goods Inventory Management System

(71) Applicants: Quan Xie, Sunnyvale, CA (US); Mingzi Yi, Sunnyvale, CA (US)

(72) Inventors: Quan Xie, Sunnyvale, CA (US); Mingzi Yi, Sunnyvale, CA (US)

(21) Appl. No.: 15/483,594

(22) Filed: Apr. 10, 2017

Related U.S. Application Data
(60) Provisional application No. 62/320,157, filed on Apr. 8, 2016.

(51) Int. Cl. G06Q 30/06; G06Q 10/08

(52) U.S. Cl. CPC G06Q 30/0633; G06Q 10/087

(57) ABSTRACT

A system featuring a processor and a memory coupled to the processor, wherein the memory is configured to store program instructions executable by the processor, wherein, in response to executing the program instructions, the processor receives a first dataset including an inventory of ingredients and receives a second dataset including a plurality of recipes, each recipe including a plurality of recipe ingredients, each recipe ingredient including an importance weighting. After reception of these data sets, the system assigns a percentage matching score for each of the plurality of recipes, wherein each percentage matching score is derived from a comparison of the first dataset against the importance weighted recipe ingredients of each respective one of the plurality of recipes, and displays a listing of the plurality of recipes in which each displayed recipe includes its assigned percentage matching score.

### BACKGROUND OF THE INVENTION

The present subject matter relates generally to inventory management system for consumable goods. More specifically, the present invention relates to systems and methods for managing the inventory of pantries and refrigerators via a mobile application.

According to the Natural Resources Defense Council (NRDC) up to 40% of food in America is wasted due to spoilage. Such spoilage creates excess cost for American families who must re-purchase food items. Many American households struggle to keep up with such spoilage issues and around 15% of American households are noted as being food insecure, meaning these households struggle to put food on the table. Food spoilage also strains natural resources by creating extra demand for food producers to grow, manufacture, and/or package food which ultimately winds up unused and in a landfill.

Current solutions to avoid or prevent food spoilage are inadequate for various reasons. One solution could be to keep less food in American homes, but this is impractical for many American families as, without food in the home, it would be necessary to dine out for meals. Given that dining out costs approximately twice what home cooked meals cost, eating out to avoid wasting food stored in the home is not a realistic solution to America's food spoilage issues.

Another solution could be to keep accurate records of food items and their respective spoilage dates. While this is a plausible solution, keeping such records is extremely time consuming with current methods. Handwritten records are impractical for various reasons, but likely the biggest drawback to keeping track of a home's food inventory this way would be the time required to record and track food spoilage dates. Various software solutions have sprung up to address food inventory management, with some solutions even featuring barcode scanners to make entry of such items as quick as possible. While faster than handwritten notes, these computerized solutions do not provide to their users any sort of guidance about when food should be used, what could be made with such food.

Accordingly, there is a need for systems and methods for managing the inventory of pantries and refrigerators via computerized algorithms, as described herein.

### BRIEF SUMMARY OF THE INVENTION

To meet the needs described above and others, the present disclosure provides systems and methods for managing the inventory of pantries and refrigerators via a mobile application.

The present invention is a software application that can be run on mobile devices, smart refrigerators and/or pantries, and any other computing device capable of running the application. The application features a graphical user interface comprised of a series of user interface “screens.” One screen features the ability to capture information about food items stored in a home's refrigerator, pantry, or elsewhere through use of a computing devices camera. The information may be collected by image recognition technology which can identify common types of food. The information may also be entered via barcode, QR code, or shopping receipt scanner, as well as manually entered via a keyboard function. The system may also store the information about each food items spoilage date, as well as the quantity of each food item, and notify users when an item is about to spoil or run out.

In this example, another screen features a shopping list that can be updated based off the inventory of foods present in a home as recorded by the system. This list may be cloud based and stored on a centralized database allowing the system to sync multiple devices running the application; which in turn allows household members to independently add items to the shopping list displayed and also update the list once needed items are acquired.

Yet another screen of the mobile application can feature a list of recipes that can be made using the ingredients currently in the home. The system may utilize a recipe algorithm that analyzes the food items stored in the home's refrigerator and/or pantry versus known dishes which can be made with such ingredients. The system may also weight the scores of certain food items critical to making a dish and present such dishes with all or most critical ingredients present in the home towards the top of the recipe list. Once the recipe algorithm has run, the system may then display the percentage of matching each recipe displayed on the list as compared to ingredients already in the home. Special accommodations may also be made by the system to account for food allergies and other dietary restrictions and/or preferences.

The system may also be described as a processor and a memory coupled to the processor, wherein the memory is configured to store program instructions executable by the processor, wherein, in response to executing the program instructions, the processor receives a first dataset including an inventory of ingredients and receives a second dataset including a plurality of recipes, each recipe including a plurality of recipe ingredients, each recipe ingredient including an importance weighting. After reception of these data sets, the system assigns a percentage matching score for each of the plurality of recipes, wherein each percentage matching score is derived from a comparison of the first dataset against the importance weighted recipe ingredients of each respective one of the plurality of recipes, and displays a listing of the plurality of recipes in which each displayed recipe includes its assigned percentage matching score.

The second data set mentioned above may include recipes acquired from an external data sources. The percentage matching score mentioned above may be displayed as a numerical value and/or displayed as a portion of a ring, the portion of the ring that is shown corresponds to the percentage of the percentage matching score. These scores may also be used to display a recipe from the plurality of recipes which has the highest percentage matching score first.

The weighting of a recipe ingredient may be previously assigned by an external data source and also influenced by shelf life (e.g., expiry date) of the ingredients. The shelf life for each of the plurality of recipe ingredients may also modify the importance weighting for a corresponding one of the plurality of recipe ingredients.

The system may also further include a camera in communication with the processor and at least one record in the inventory of ingredients is generated in response to image recognition software that identifies at least one ingredient from data captured by the camera.

The system may yet further, in response to the comparison of the first dataset against the importance weighted recipe ingredients of each respective one of the plurality of recipes, the processor further automatically adds a recipe ingredient present in the second data set that was absent from the first data set to a shopping list.

For example, based on the items listed in the food inventory, the recipe algorithm may determine that all but one of the ingredients for chicken parmesan are in the inventory. However, there is a substantial difference in the recipe if the inventory is missing chicken, rather than missing, for example, a minor ingredient like red pepper flakes. Thus, the percentage matching may be calculated either as a straight percentage of ingredients or it may be determined based on a weighted calculation in which the most important ingredients have a larger impact on the percentage matching. Therefore, in some examples, a single missing ingredient of lesser importance might produce a percentage matching of 95%, while a single missing ingredient of greater importance might produce a lower percentage matching, for example 80%.

A goal of the present invention is to waste less food stored in homes. Many people in America and elsewhere in the world struggle with providing food for their households and a good deal of food is wasted regularly due to food spoilage. The present invention allows households to utilize food that is going to spoil soon by reminding the household members of the spoilage date. The system also facilitates consuming such food by suggesting recipes in which the item(s) about to spoil may be utilized. This functionality not only allows households to consume food more efficiently, but also lowers the strain on the natural resources needed to produce food wasted by spoilage.

An advantage of the present invention is that it allows households to understand what meals can be made with ingredients already in the inventory. Cooking is a skill not all possess, but most people can understand and follow a recipe. Many may find cooking intimidating because they might not know what meals they can create provided the food they currently have in their home. The present invention removes any doubt such persons might have about cooking, allowing them to quickly assess if they have all the ingredients needed to make a dish and also have the recipe readily available for reference.

Another advantage of the present invention is that it allows household members to know what food needs to be purchased from a store. The present invention allows consumers to track the spoilage of items in their refrigerator, pantry, or anywhere else they store food and can also be set up to notify and automatically (or manually) add food items a household needs to a shopping list. Items can also be added to a shopping list based off the recipes presented by the system so that if a few (or conversely many) ingredients are missing to make a dish, every household member will know exactly what ingredients to buy to make that dish.

Yet another advantage of the present invention is the ability to utilize a consistent, closed set of ingredients for the inventory of a home's food stores as recorded by the system. This same consistent description set is also used for the shopping list screen as well as recipes suggested by the system which allows for items to be readily matched across all system functions. This use of a closed set of ingredients prevents confusingly similar ingredients (e.g., system has separate records for Olive Oil and Extra Virgin Olive Oil) while also preventing the mislabeling of even the most difficult to spell or describe ingredients (e.g., Quinoa).

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an overview diagram of the pantry and refrigerator inventory management system.

FIG. 2 is a screen of the pantry and refrigerator inventory management mobile application which users are presented upon initiating the application.

FIG. 3 is a screen of the pantry and refrigerator inventory management mobile application through which users can manage their profile.

FIG. 4A is a screen of the pantry and refrigerator inventory management mobile application through which users can view and update the amount and types of food currently in their household.

FIG. 4B is a database table of an inventory records database.

FIG. 5 is a screen of the pantry and refrigerator inventory management mobile application through which users can view and update shopping lists for their household.

FIG. 6 is a screen of the pantry and refrigerator inventory management mobile application through which a user is updating the quantity of a food item needed by a household on a shopping list.

FIG. 7 is a screen of the pantry and refrigerator inventory management mobile application through which a user is marking items off a household shopping list.

FIG. 8A is a screen of the pantry and refrigerator inventory management mobile application that displays recipe suggestion results.

FIG. 8B is a plurality of recipes stored in a recipe database.

FIG. 9 is a flow chart illustrating the system suggesting recipes.

FIG. 10 is a screen of the pantry and refrigerator inventory management mobile application that displays a recipe.

### DETAILED DESCRIPTION OF THE INVENTION

The present invention may be described as a computerized system or method for suggesting recipes based off the supply of consumable goods available. Consumable goods may be any goods which are not of a permanent nature, but the most relevant goods which a tracked by the present invention include food, drinks, cooking supplies, and other common household goods. The system or method may be implemented across multiple devices (e.g., a server, smart appliances, and computing devices of end users) or be contained within a single computing device. The system or method may monitor the inventory of consumable goods for a household (or commercial kitchen, restaurant, school cafeteria, etc.) and track various data points about the goods present in a given location (or multiple locations). One point of data the system or method may keep track of is the expiry date (or how many days since acquired) of the consumable goods in a given location. The system or method may download recipes to suggest from the internet or other external sources and when the system or method is used to suggest a recipe, it may suggest one which uses ingredients that are near expiry over recipes that feature ingredients further away from spoilage.

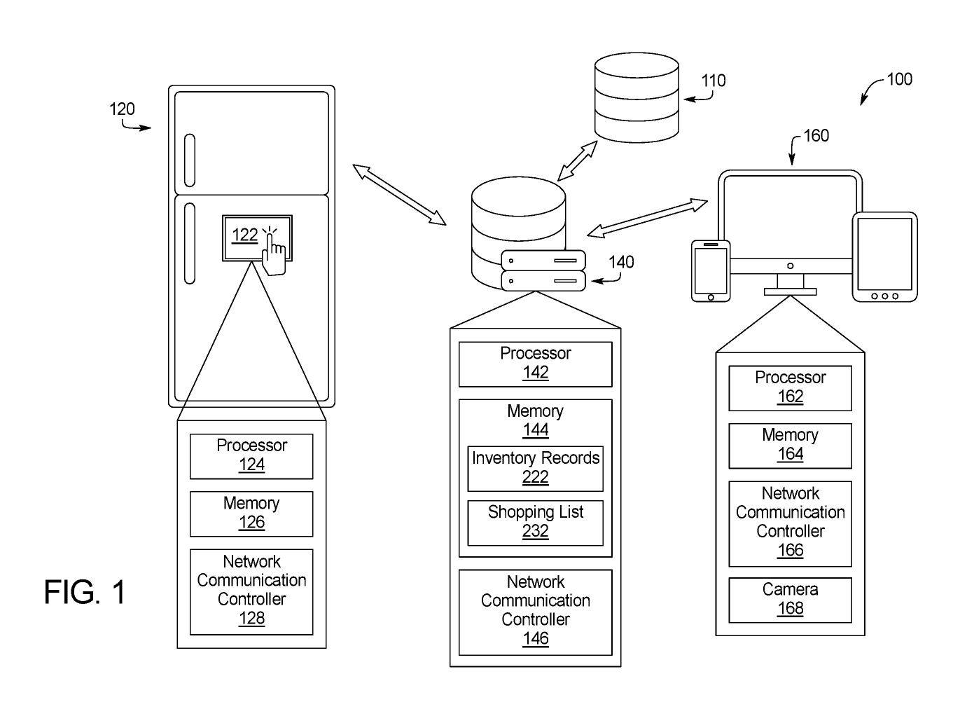

FIG. 1 is an overview diagram of the pantry and refrigerator inventory management system 100. The system 100 may feature an external data source 110, smart refrigerator 120, sever 140, and end user device(s) 160. The smart refrigerator 120 may feature a touchscreen control panel 122, processor 124, memory 126, and communications adapter 128. The communications adapter 128 of the smart refrigerator 120 may utilize any wireless or wired communications protocol (e.g., Wi-Fi, Bluetooth, ZigBee, Ethernet, etc.) to communicate with the sever 140 and end user device(s) 160. The server 140 (which also features a processor 142, memory 144, and communications adapter 146) acts as a centralized data store which receives data from the smart refrigerator 120, end user device(s) 160, and external data sources(s) 110. The data collected and stored by the server 140 may be analyzed via various algorithms (stored in the memory 144 of the server 140) and data generated from these algorithms may be transmitted out to the smart refrigerator 120 and/or end user devices 160 for display.

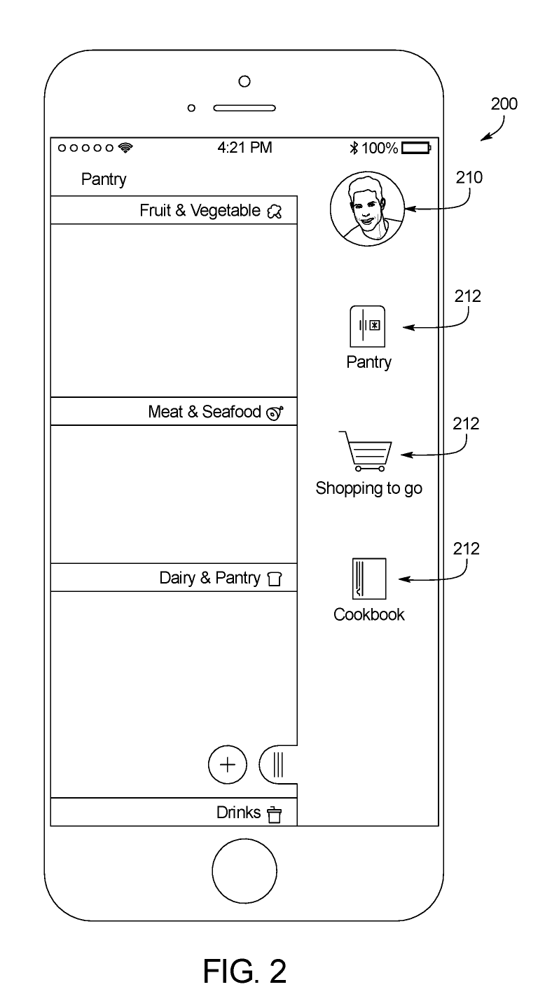

The end user device(s) 160 may be any form of computing device capable of running a software application including: smart phones, tablets, smart appliances, home computers, computer displays in automobiles, etc. Such device(s) may feature a processor 162, memory 164, communications adapter 166, and camera 168. A given end user device 160 may also feature an application 200 (shown in FIGS. 2-10) which enables end users to check and update information regarding their food and drink stores, see recipe suggestions, etc. It should be noted that various system 100 components may be integrated into one another as technology advances. For example, a smart refrigerator 120 may have a camera 168 built into it so that the smart refrigerator can automatically identify the items within it.

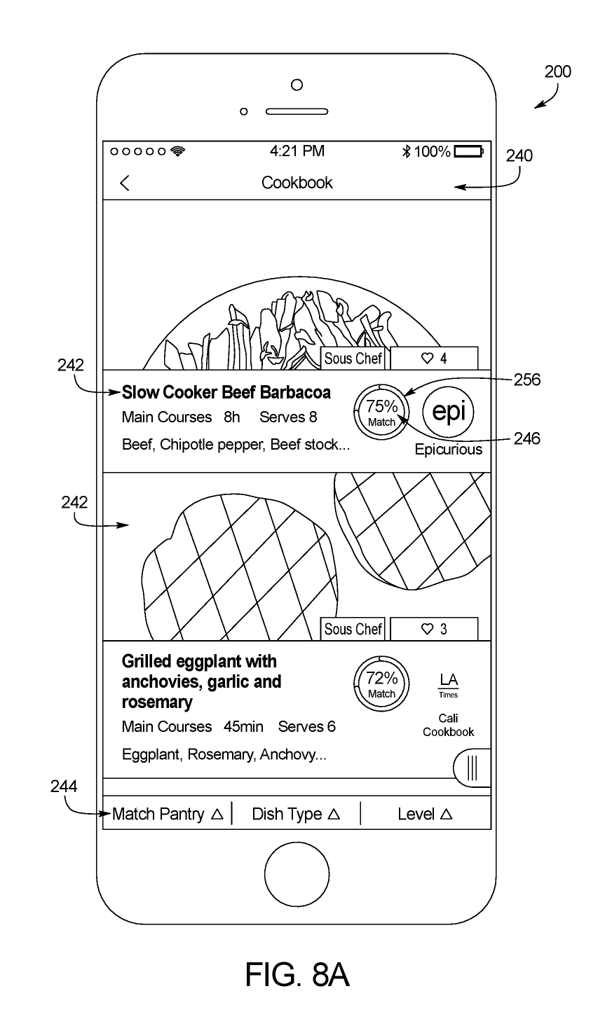

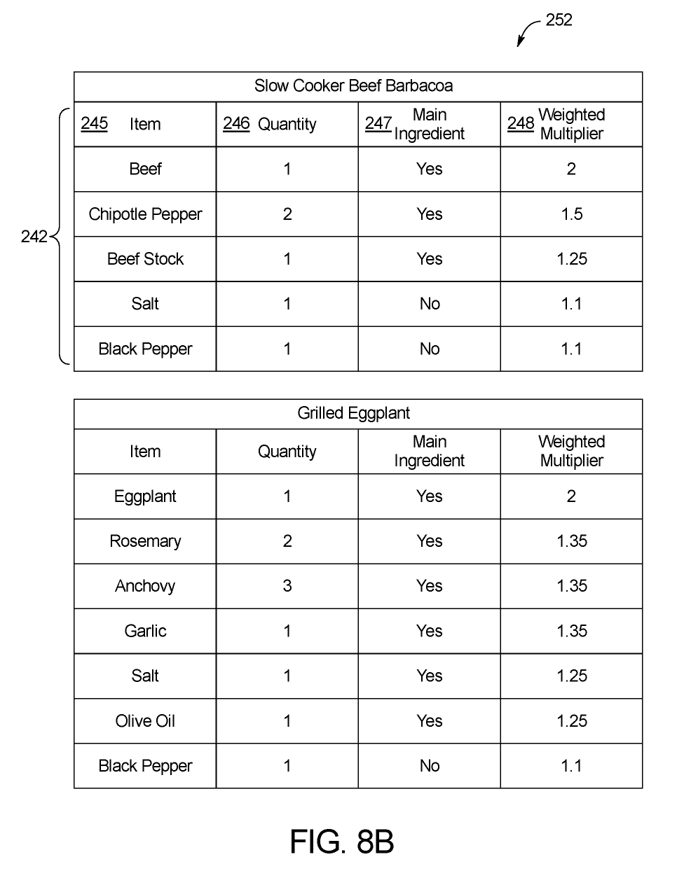

The system 100 shown may enable end user device(s) 160 to be utilized by members of a household to update the inventory records 222 for various consumable items (e.g., food, drink, cooking oil, etc.) within a home. These consumable goods may act as ingredients in recipes 242 suggested by the system 100 (seen in FIGS. 8A-10). Updates regarding the inventory records 222 may be synced across all system components (including the smart refrigerator 120). This enables someone cooking a meal at home to review what ingredients they have on hand against a recipe acquired from an external data source 110 (e.g., internet databases, websites, RSS feeds, or any other external source of data which may be communicated with to receive recipe data from) via the touchscreen display 122 of their smart refrigerator 120 and update the home's shopping list 232 directly from this interface for any missing ingredients needed.

FIG. 2 is a screen of the pantry and refrigerator inventory management mobile application 200 which users are presented upon initiating the application 200. As shown in FIG. 2, when an end user opens the inventory management mobile application 200 they are presented with a home screen 210 from which they can access the application's pantry inventory management screen 220, the shopping list screen 230, the recipe suggestion screen 240, and the profile management screen 260 via corresponding touchscreen control buttons 212.

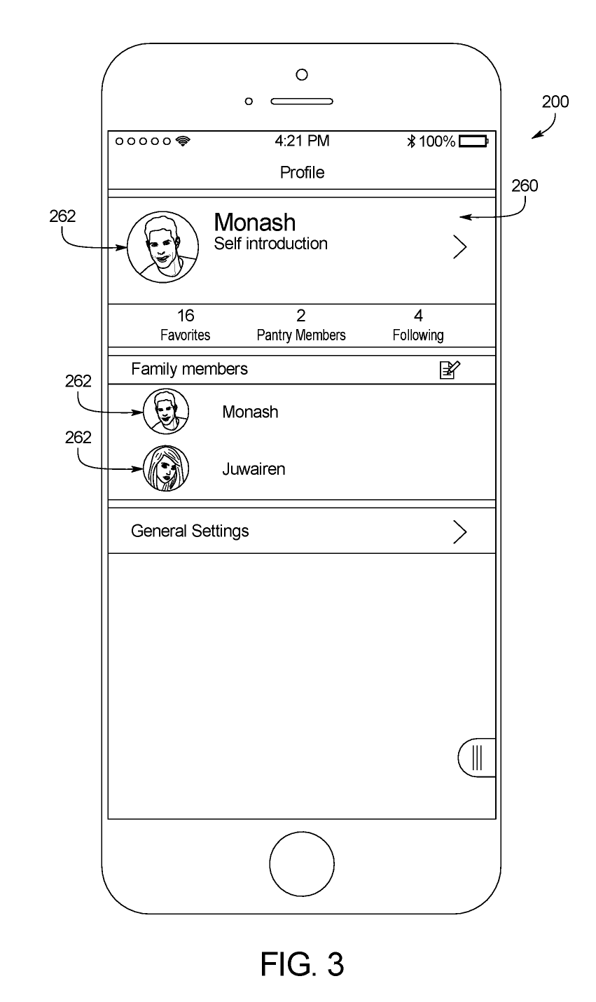

FIG. 3 is a screen of the pantry and refrigerator inventory management mobile application 200 through which end users can manage their profile and system 100 settings. As shown in FIG. 3, the profile management screen 260 enables end users to create a profile stored by the system 100, add and edit personal information to this profile, and also manage group members. The information input into the application 200 may be stored locally on an end user device 160 and/or synced with the system's 100 server 140. The settings regarding group members can be used to define which end user profiles have access to the inventory information for a given instance of the system 100. In FIG. 3, two end users, Monash and Juwairen, are members of the same household and have access to the same inventory information. It should be noted each end user profile may be granted access to more than one instance of the system 100 (e.g., an end user can access the inventory information for multiple households) and each instance of the system 100 can cover multiple households. The profile management screen 260 also allows users to edit general application 200 settings.

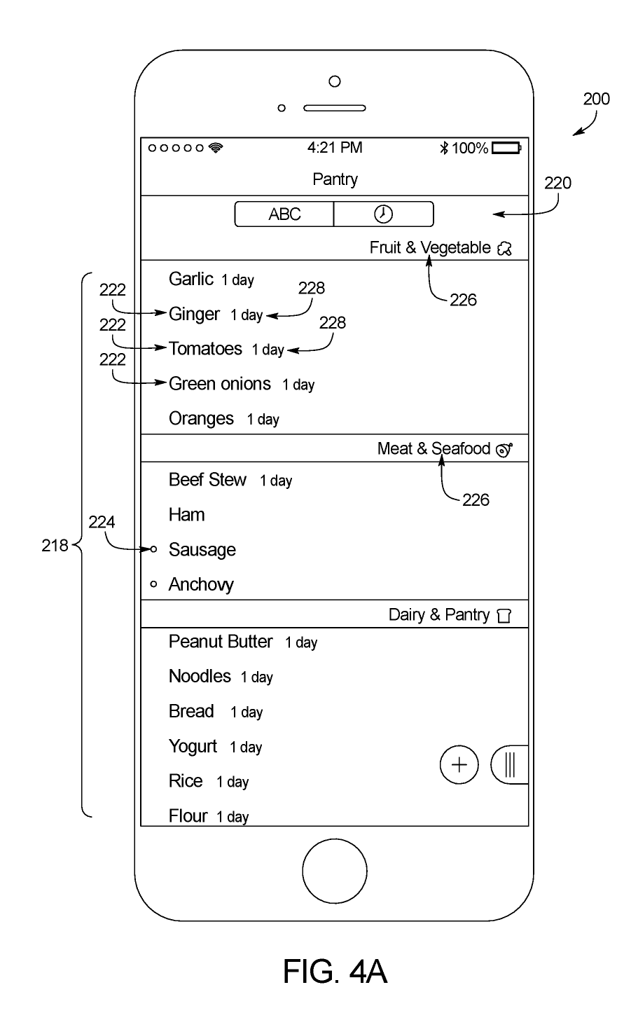

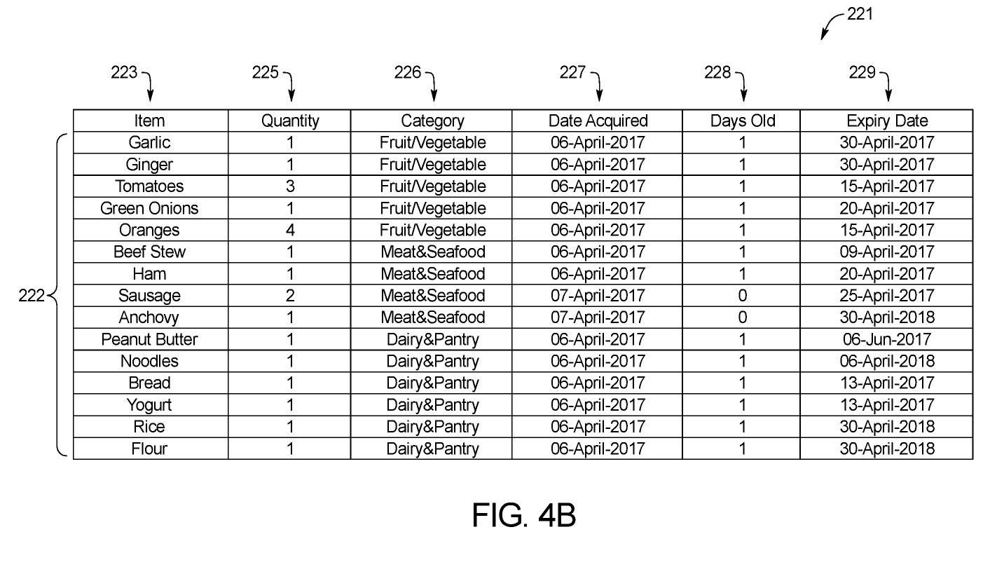

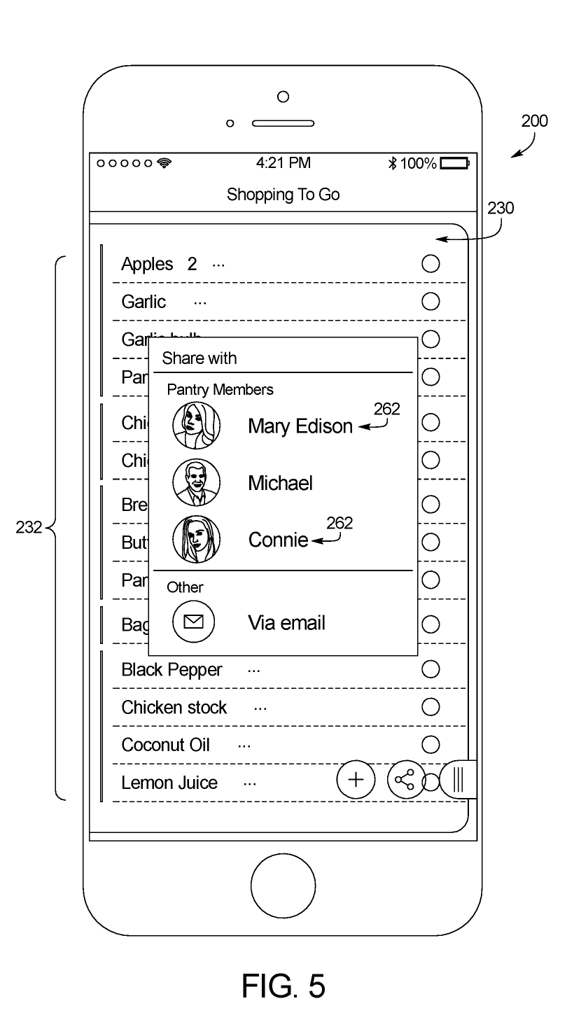

FIG. 4A is a screen of the pantry and refrigerator inventory management mobile application 200 through which users can view and update the amount and types of food and other consumable goods currently in their household. As shown in FIG. 4, the inventory management system mobile application 200 may display a list 218 of the various foods in a home's refrigerator, pantry, or elsewhere in the home as recorded by the system 100 on the pantry inventory management screen 220. This list 218 of consumable items in the home features an inventory record 222 for each item and these records 222 may be shared across multiple user devices 160 and profiles. The inventory records 222 may also contain information regarding various attributes associated with the items such as expiry date, if the item is kosher/halal, sodium content, etc. When one user adds consumable items to a home's inventory records 222, these new items will be designated with a single dot 224 for other users viewing the list 218 of inventory records 222. An end user may update the list 218 of inventory records 222 by utilizing image recognition software which teams with an end user device's 160 camera 168 to identify new food being brought into a home. Users may also enter this information manually via traditional input means (e.g., keyboard function, talk-to-text, etc.) Updating the inventory records 222 for food within the home with additional food items may also automatically remove these food items from the household shopping list 232 (shown in FIGS. 5-7).

FIG. 4B is a database table of an inventory records database. As shown in FIG. 4B, each inventory record 222 has a unique entry in at least one inventory records database 221 of the system 100. The inventory records database 221 can be stored in the memory of an end user device 160 and/or the system's server 140 (Server Memory 144 and End User Device Memory 164 can be seen in FIG. 1). Each inventory record 222 may store various data about a certain consumable good. For instance, the inventory record 222 for the consumable good “Garlic” has information populated in the inventory records database 221 for the item field 223, quantity field 225, category field 226, date acquired field 227, days old field 228, and expiry date 229. Some of these fields have shown on the pantry inventory management screen 220 (e.g., item field 223, category field 226, and days old field 228) while the other fields may be used by the system 100 for various calculations, report generation, etc.

The quantity field 225 contains a numerical value which can be expounded upon in this or another database to define what the numerical value (“1” for Garlic) corresponds to. In the case of “Garlic”, the “1” may correspond to one clove of garlic as number of cloves is a common measure for this consumable good in recipes. The category field 226 defines a piece of metadata concerning what category a given inventory record 222 belongs to. This enables the pantry inventory management screen 220 to display similar consumable items together (e.g., all fruits a shown together as seen in FIG. 4A). The date acquired field 227 and days old field 228 note when a consumable good was acquired. This is useful for users of the system 100 because they can quickly check the freshness of bread, milk, eggs, etc. The expiry date field 229 also aids in keeping track of the freshness of consumable goods in a home and can be entered manually for an inventory record 222 or automatically assessed based off predefined expiry dates stored by the system 100.

FIG. 5 is a screen of the pantry and refrigerator inventory management mobile application 200 through which users can view and update shopping lists for their household. As shown in FIG. 5, a shopping list screen 230 may enable the creation and sharing of shopping lists 232 via the mobile application 200. Users may add items to a shopping list 232 which were depleted from their home inventory, add items via the recipe suggestion screen (shown in FIG. 8A), or manually add the items to the list via keyboard function, etc. Additionally, items may be added to the list 232 shown on this screen 230 via image recognition software so if a user samples a food item they enjoy at a friend's house, they can scan it with the image recognition software built into the mobile application 200 (in combination with their end user device camera 168) and add the item to their home's shopping list 232.

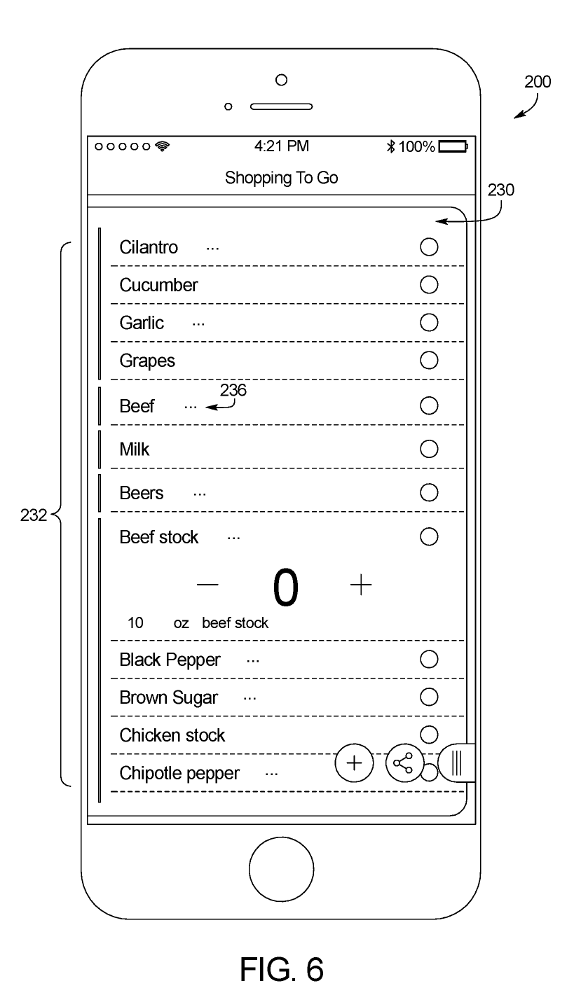

FIG. 6 is a screen of the pantry and refrigerator inventory management mobile application 200 through which a user is updating the quantity of a food item needed by a household on a shopping list 232. A shown in FIG. 6, on the shopping list screen 230, users can tap items on their home's shopping list 232 to update details about them, edit the quantity needed, and to view the original quantity required for a recipe 242 found by the system (shown in FIG. 8A). Also, shown in FIG. 6, items added from recipes 242 found by the system are indicated with three dots 236 behind them which act as a link to the recipe 242 to provide quick reference for the user(s).

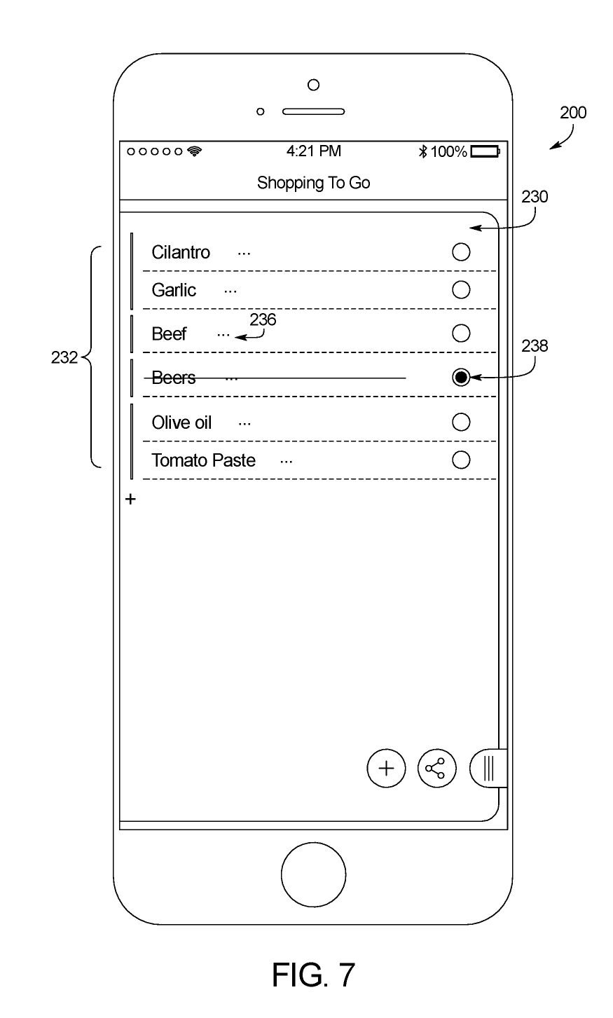

FIG. 7 is a screen of the pantry and refrigerator inventory management mobile application through which a user is marking items off a household shopping list 232. As shown in FIG. 7, when a household member acquires items on the shopping list 232, this user taps the circle 238 displayed on the right side to check items off the list 232. When this is done, an animated line starts to draw across the item from left side of the screen. This animation lasts for a few seconds and after that, the item will disappear from shopping list 232 and is added to the pantry inventory list 218 (shown in FIG. 4A). This automatic update is propagated across all end user devices 160 which have access to the shopping list 232.

FIG. 8A is a screen of the pantry and refrigerator inventory management mobile application which displays recipe suggestions 242. As shown in FIG. 8A, the inventory management system 100 (on the recipe suggestion screen 240) may automatically suggest recipes 242 based off the inventory records 222 within a household. These recipes may be preloaded on the system 100 or browsed in real time via external data source(s) 110. The system 100 may identify recipes 242 to suggest by performing a search of recipes 242 based off the inventory records 222 for the home when the user selects the “Match Pantry” filter 244 (selectable at the bottom of the screen). Once this option is selected, the system will rank recipes 242 automatically based on the matching percentage (displayed as a percentage matching score 246) of ingredients present in the household food stores and display a list of such recipes 242 in preview form to the user. It should be noted this ranking is done by a recipe/ingredient matching algorithm. This algorithm may weight certain food items over others when performing this analysis; for example, ranking chicken breast over parsley when comparing what ingredients are present in a home to a recipe which can be made with such ingredients. The algorithm may also account for food preferences (e.g., vegetarian diet) or dietary restrictions (e.g., low salt diet) when suggesting recipes 242. A discussion and examples of the ingredient matching algorithm and the system 100 weighting certain items over others can be found in the discussion of FIG. 8B.

In addition to the percentage matching score 246 displayed for an end user, the closeness of a match between on hand ingredients (e.g., inventory records 222 of consumable goods for a given location) and a recipe 242 is further illustrated by a ring visual element 256. This ring visual element 256 displays as a portion of a ring (up to a full ring for a 100% match) and the portion of the ring that is shown corresponds to the percentage of the percentage matching score. For example, a 75% match is shown in FIG. 8A for a “beef barbacoa” recipe 242 and thus 75% of a ring is shown on the ring visual element 256.

FIG. 8B is a plurality of recipes 242 stored in a recipe database 252. As shown in FIG. 8B, the system 100 may store recipes 242 (either preloaded on the system 100 or acquired in real time) in one or more database tables. The information stored by the system 100 concerning each recipe 242 may be stored in database fields including: an item field 245, quantity field 246, main ingredient field 247, and weighted multiplier field 248. The item field 245 identifies the common name of each consumable good called for in a recipe. One recipe 242 shown in FIG. 8B is for slow cooker beef barbacoa and the item field 248 entries include “Beef” and “Chipotle Peppers”. The database also records the quantity of each consumable good needed for a given recipe (such quantities can further be defined in this or other database tables if different types of beef, peppers, etc. are acceptable for the recipe). The main ingredient field 247 and weighted multiplier field 248 define if a consumable good called for by the recipe 242 or if the dish can still be created without it. For beef barbacoa, beef is the most important ingredient as the recipe cannot be made without it. Accordingly, “Beef” is noted as being a main ingredient 247 (“Yes”) and assigned a weighted multiplier 248 of “2”.

The weighted multiplier field 248 is used by the system 100 to determine if a recipe matches the inventory records 222 for the system 100. The numerical value assigned to the weighted multiplier field 248 may be utilized by an ingredient matching algorithm to assess which recipes most closely match the consumable goods present in a household. One example of the calculations carried out by this algorithm may involve multiplying the numerical value stored in the weighted multiplier field 248 by the numerical value stored quantity field 246. The values generated from this multiplication may then be summed and divided by a number which would be representative of all ingredients needed for a recipe 242 being present in the inventory records 222 of the system 100. This would generate a percentage matching score 246 which would enable the system to determine which recipes 242 most closely match the inventory records 222 for the system 100.

The system 100 may also assign additional modifiers when determining which recipes 242 most closely match the inventory records 222 for the system 100. One such additional modifier may account for the expiry date of consumable goods currently present in inventory records 222. For example, if there is an inventory record 222 for beef which is about to expire, the system 100 may assign it an additional weighted modifier to increase its percentage matching score 246 and place the recipe towards the top of the recipe suggestion screen 240.

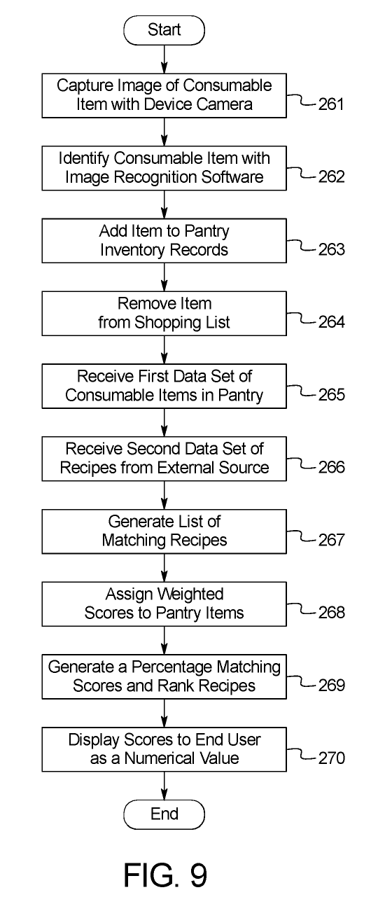

FIG. 9 is a flow chart illustrating the system 100 suggesting recipes 242. As shown in FIG. 1, at a first step 261, the system 100 may capture an image of a consumable item with an end user device's 160 camera 168. The image of the consumable good captured by the system 100 may then be analyzed via image recognition software to automatically identify the consumable good at a second step 262. At a third step 263, the consumable good identified by the system 100 may be added to the inventory records database 221 and then automatically removed from the shopping list 232 (step 264). At a fifth step 265, after the consumable good is added to the inventory records database 221 the system 100 then receives a first data set of consumable items in pantry of a household. The system 100 then receives a second data set from an external data source 110 at step 267. The system 100 then analyses and generates a list of recipes which match consumable items in a household's panty. The system 100 then, at step 268, assigns weighted scores to consumable goods in the inventory records database 221. The weighted scores assigned can be based off various factors such as expiry date of the various goods and dietary preferences of the end users of the system 100. The weighted scores for the items present in the inventory records database 221 may then used to generate a percentage matching score 246 (step 269) which the system 100 utilizes to rank the recipes from the second data set. At a final step 270, the system 100 will display the weighted score to an end user as a numerical value making the rankings easy to comprehend.

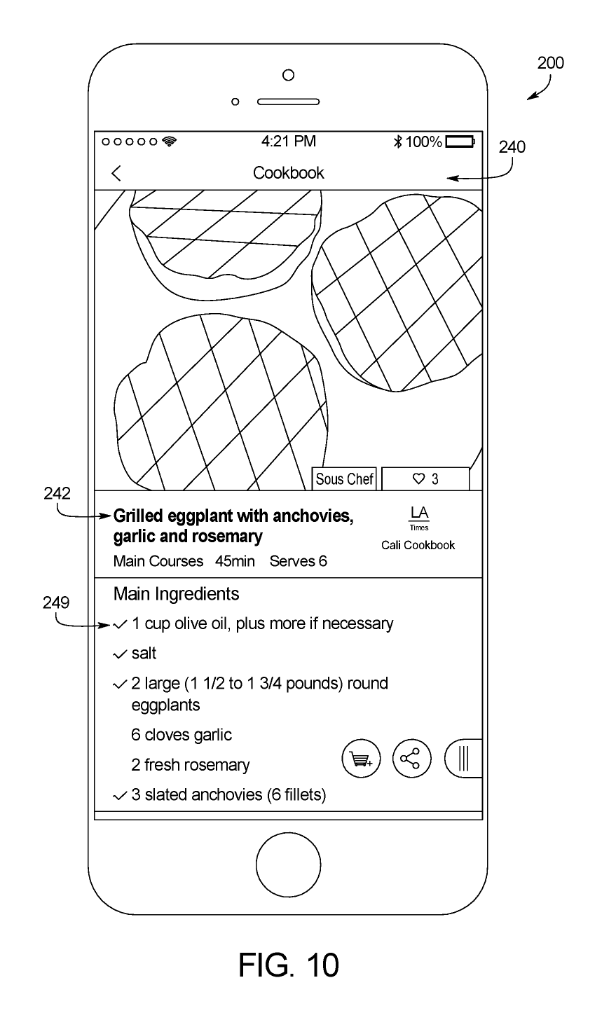

FIG. 10 is a screen of the pantry and refrigerator inventory management mobile application 200 which displays a suggested recipe 242. As shown in FIG. 9, when a user selects a suggested recipe 242 (shown in FIG. 8A), the inventory management system will display the full recipe 242 and indicate (with a check mark 249) which ingredients are present in the home and which are not. Food items needed for the recipe 242 can then be selected for addition to the shopping list 232 (shown in FIGS. 5-7) without the need to return to the shopping list screen 230.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system, comprising:
a processor;
a memory coupled to the processor, wherein the memory is configured to store program instructions executable by the processor;
wherein, in response to executing the program instructions, the processor:
receives a first dataset including an inventory of ingredients;
receives a second dataset including a plurality of recipes, each recipe including a plurality of recipe ingredients, each recipe ingredient including an importance weighting;
assigns a percentage matching score for each of the plurality of recipes, wherein each percentage matching score is derived from a comparison of the first dataset against the importance weighted recipe ingredients of each respective one of the plurality of recipes, and
displays a listing of the plurality of recipes in which each displayed recipe includes its assigned percentage matching score.

2. The system of claim 1, wherein the second data set includes at least one recipe acquired from an external data source.

3. The system of claim 1, wherein the percentage matching score is displayed as a numerical value.

4. The system of claim 1, wherein the percentage matching score is displayed as a portion of a ring, the portion of the ring that is shown corresponds to the percentage of the percentage matching score.

5. The system of claim 1, wherein the listing of the plurality of recipes displays recipes having the highest percentage matching score first.

6. The system of claim 1, wherein the importance weighting of a recipe ingredient is previously assigned by an external data source.

7. The system of claim 1, wherein the inventory of ingredients includes a remaining shelf life for each of the plurality of recipe ingredients, wherein, when assigning the percentage matching score, the remaining shelf life for each of the plurality of recipe ingredients modifies the importance weighting for a corresponding one of the plurality of recipe ingredients.

8. The system of claim 1, wherein the system further includes a camera in communication with the processor and at least one record in the inventory of ingredients is generated in response to image recognition software that identifies at least one ingredient from data captured by the camera.

9. The system of claim 1, wherein, in response to the comparison of the first dataset against the importance weighted recipe ingredients of each respective one of the plurality of recipes, the processor further automatically adds a recipe ingredient present in the second data set that was absent from the first data set to a shopping list.

10. A method, comprising:
receiving a first dataset including an inventory of ingredients;
receiving a second dataset including a plurality of recipes, each recipe including a plurality of recipe ingredients, each recipe ingredient including an importance weighting;
assigning a percentage matching score for each of the plurality of recipes, wherein each percentage matching score is derived from a comparison of the first dataset against the importance weighted recipe ingredients of each respective one of the plurality of recipes; and
displaying a listing of the plurality of recipes in which each displayed recipe includes its assigned percentage matching score.

11. The method of claim 10, wherein the second data set includes at least one recipe acquired from an external data source.

12. The method of claim 10, wherein the percentage matching score is displayed as a numerical value.

13. The method of claim 10, wherein the percentage matching score is displayed as a portion of a ring, the portion of the ring that is shown corresponds to the percentage of the percentage matching score.

14. The method of claim 10, wherein the listing of the plurality of recipes displays recipes having the highest percentage matching score first.

15. The method of claim 10, wherein the importance weighting of a recipe ingredient is previously assigned by an external data source.

16. The method of claim 10, wherein the inventory of ingredients includes a remaining shelf life for each of the plurality of recipe ingredients, wherein, when assigning the percentage matching score, the remaining shelf life for each of the plurality of recipe ingredients modifies the importance weighting for a corresponding one of the plurality of recipe ingredients.

17. The method of claim 10, wherein the system further includes a camera in communication with the processor and at least one record in the inventory of ingredients is generated in response to image recognition software that identifies at least one ingredient from data captured by the camera.

18. The method of claim 10, wherein, in response to the comparison of the first dataset against the importance weighted recipe ingredients of each respective one of the plurality of recipes, the processor further automatically adds a recipe ingredient present in the second data set that was absent from the first data set to a shopping list.
